(19) United States
(12) Patent Application Publication
(10) Pub. No.: US 2005/0204369 A1
(43) Pub. Date: Sep. 15, 2005

(54) Data recording method, data recording device, and data recording medium

(76) Inventor: Koubun Sakagami, Kanagawa (JP)

Correspondence Address: DICKSTEIN SHAPIRO MORIN & OSHINSKY LLP, 2101 L Street, NW, Washington, DC, 20037, US

(21) Appl. No.: 11/078,510

(22) Filed: Mar. 14, 2005

(30) Foreign Application Priority Data
Mar. 15, 2004 (JP) 2004-072670

(51) Int. Cl. H04N 1/32

(52) U.S. Cl. 720/600

(57) ABSTRACT

A data recording method is disclosed that is suitable for multi-level recording and suitable for correction of randomly occurring errors. In the recording method, sector address data are appended to user data in units of sectors, plural user data sets and the sector address data are separated and arranged to form a data block, and recording is performed so that error correcting data associated with a product code are appended to data including the user data in the data block.

### BACKGROUND OF THE INVENTION

1. Field of the Invention

The present invention relates to a data recording method, data recording device, and data recording medium for optical data recording.

2. Description of the Related Art

Published Japanese Translation of PCT International Application No. 2002-521789 (below, referred to as “reference”) discloses a technique for encoding data including plural words by interleaving in units of words. In this technique, user data and address data are processed separately, error correction data are appended thereto, and then are recorded in an optical disk (refer to FIG. 19 in the reference). The user data are treated as an ECC (Error Correcting Code) cluster, and the address data are treated as a BIS cluster. In the ECC cluster error correcting method, not a product code, but parity data (error correcting data) are appended to a vertical data series. In this technique, an address is read out through a BIS cluster, and errors in the horizontal direction are detected simultaneously. After that, assuming all errors are burst errors (continuous error) in the horizontal direction, the address is used as position information of error data in the ECC cluster. With position information of error data obtained by the BIS cluster, error correction is executed in the ECC cluster.

However, in the technique disclosed in the above reference, because the error correcting method does not utilize the product code, this method is not applicable when the errors randomly occur.

### SUMMARY OF THE INVENTION

It is a general object of the present invention to solve one or more problems of the related art.

A specific object of the present invention is to provide a data recording method for an optical disk system that uses an error correcting method suitable for multi-level recording, and particularly, suitable for an optical disk system in which errors occur randomly, and a data recording device and the method thereof, and data recording medium recorded by the data recording device.

According to a first aspect of the present invention, there is provided a data recording method for recording data sets in a data recording medium, said method comprising the steps of: appending an address data item to the recording data sets; separating and arranging a plurality of the recording data sets and the address data item to form a data block; and recording the recording data sets so that error correcting data associated with a product code are appended to data including the recording data sets in the data block.

According to a second aspect of the present invention, there is provided a data recording device for recording data sets in a data recording medium, said data recording device comprising an appending unit configured to append an address data item to the recording data sets; a block formation unit configured to separate and arrange a plurality of the recording data sets and the address data item to form a data block; and a recording unit configured to record the recording data sets so that error correcting data associated with a product code are appended to data including the recording data sets in the data block.

According to a third aspect of the present invention, there is provided a data recording medium in which data sets are recorded, wherein an address data item is appended to the recording data sets; a plurality of the recorded data sets and the address data item are separated and arranged to form a data block; and the recorded data sets are recorded so that error correcting data associated with a product code are appended to data including the recorded data sets in the data block.

According to the present invention, because recording data sets and address data items, such as sector addresses, are separated and arranged to form a data block, and data are recorded with the error correcting data associated with a product code being appended, the present invention is suitable to data recording in an optical disk system in which errors occur randomly, and facilitates reading out of the address data items.

These and other objects, features, and advantages of the present invention will become more apparent from the following detailed description of preferred embodiments given with reference to the accompanying drawings.

### BRIEF DESCRIPTION OF THE DRAWINGS

FIG. 1A is a diagram illustrating a data structure of sector data including user data in units of 2 KB (that is, 2048 bytes) to be recorded in a recording medium;

FIG. 1B is a diagram illustrating a data structure of address information indicating an address of a sector;

FIG. 2 is a diagram illustrating a data structure including sector data contained in two sectors and the address information corresponding to the sector data;

FIG. 3 is a diagram illustrating a structure of the data obtained by appending error correcting data to 64 sectors of data;

FIG. 4 is a diagram illustrating data obtained by interleaving the PO data lines;

FIG. 5 is a diagram illustrating data obtained by appending address identification data (the eight bits on the left side in each line) to each data line after interleaving;

FIG. 6A is a diagram illustrating a data structure of sector data including user data in units of 2 KB (that is, 2048 bytes) to be recorded in a recording medium;

FIG. 6B is a diagram illustrating a data structure of address information indicating an address of a sector;

FIG. 7A is a diagram illustrating a data structure of the sector data;

FIG. 7B is a diagram illustrating a data structure of the address information;

FIG. 8 is a diagram illustrating a structure (1 ECC block) of the data obtained by appending error correcting data to 64 sectors of data by using a product code;

FIG. 9 is a diagram illustrating data obtained after interleaving the PO data lines;

FIG. 10 is a diagram illustrating data obtained by appending address identification data (the nine bits on the left side in each line) to each data line after interleaving; and

FIG. 11 is a block diagram illustrating an example of a configuration of a recording device 1 according to an embodiment of the present invention.

### DESCRIPTION OF THE PREFERRED EMBODIMENTS

Below, preferred embodiments of the present invention are explained with reference to the accompanying drawings.

### First Embodiment

In the present embodiment, a recording method according to a first embodiment of the present invention is described.

The recording method of the present embodiment is related to data recording in a recording medium such as an optical disk. Below, an optical disk is taken as an example of the recording medium.

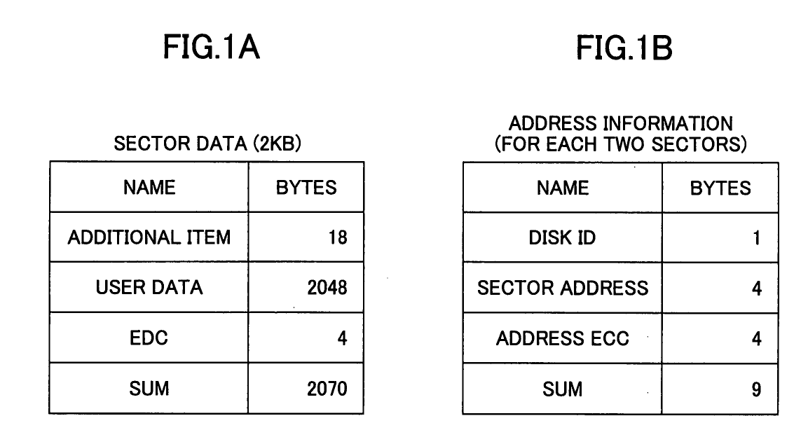

FIG. 1A is a diagram illustrating a data structure of sector data including user data in units of 2 KB (that is, 2048 bytes) to be recorded in a recording medium.

FIG. 1B is a diagram illustrating a data structure of address information indicating an address of a sector.

The sector data include user data, additional information, and EDC (Error Detection Code). The user data form various contents having size of 2 KB, for example, image data, audio data, computer software, and so on. The additional information indicates future expandability, and other additional information such as user information, manufacture information, and copyright protection. EDC is data added to the additional information and the user data for error detection.

The address information includes optical disk identification data (ID), sector addresses, and address ECC data (Error correcting code). The optical disk identification data include information for identifying the optical disk, such as, whether the disk is Read-Only or Re-Writable, whether the disk includes one recording layer or multiple recording layers.

The sector address data indicate addresses assigned to user data each having size of 2 KB. Here, it is assumed that the address information is appended to each two sectors, the address of each two sectors being defined to be the sector address of the even sector.

The address ECC data are four-byte data for error correction which are added to the address data.

In the present embodiment, the user data and the sector addresses, which correspond to the recording data sets and the address data items, respectively, are separated and arranged to form data blocks, and are recorded in the optical disk.

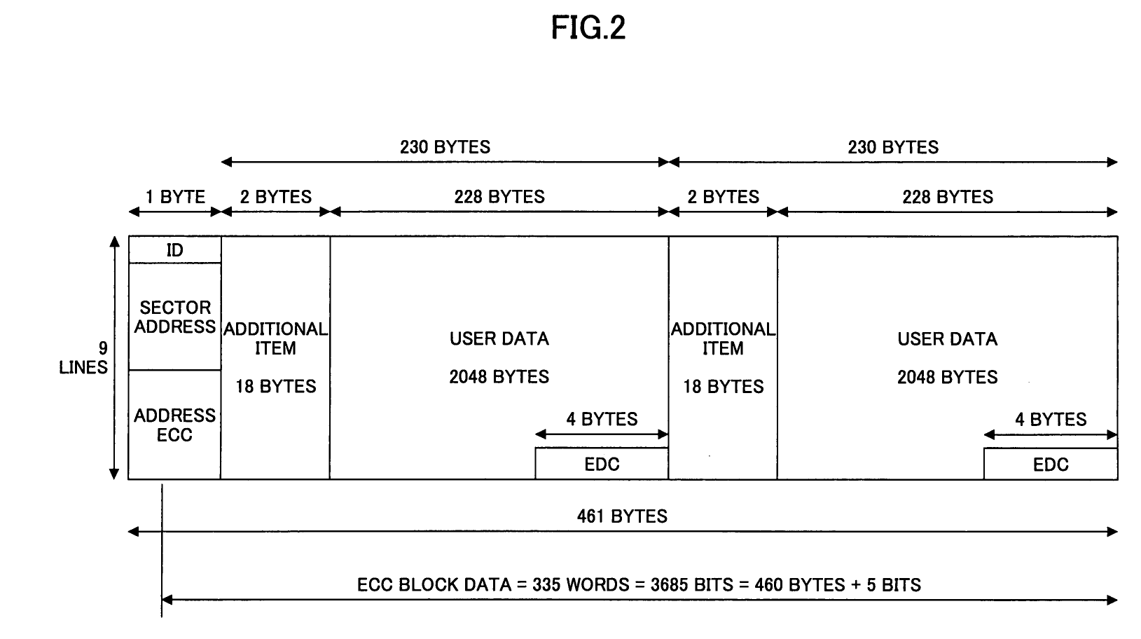

FIG. 2 is a diagram illustrating a data structure including sector data contained in two sectors and the address information corresponding to the sector data. Here, the sector address of the sector data on the left side in FIG. 2 is set to be even, and the sector address of the sector data on the right side in FIG. 2 is set to be odd. For example, the sector address of the sector data on the left side is set to be zero, and the sector address of the sector data on the right side is set to be 1. With these settings, the sector address in the address information equals zero.

In the data structure illustrated in FIG. 2, data contained in one line include 461 bytes (one byte equals eight bits), but error correction for data including the user data is performed only on the 335 words on the right side. Here, one word is defined to be 11 bits. Hence, the size of the data to be processed by error correction is calculated as follows: the size of the data to be error-corrected is 335 words; this corresponds to 11 bits×335 word=3685 bits, and further corresponds to 460 bytes+5 bits.

That is, error correction is not performed on the left three bits of the address information. Because the address information includes the ECC data, and because error correction on the address information is not necessary after searching for data on the optical disk, or after reading out addresses for detecting an error correcting block. Even if the address information is excluded from error correction operations on the user data, there is not any problem.

Then, eleven bits of binary data are transformed into four eight-level data items, and are recorded in the optical disk by multi-level recording. Therefore, if it is set that one line of the sector data contains data in units of words, with each word including 11 bits, transformation to the multi-level data items can be performed easily.

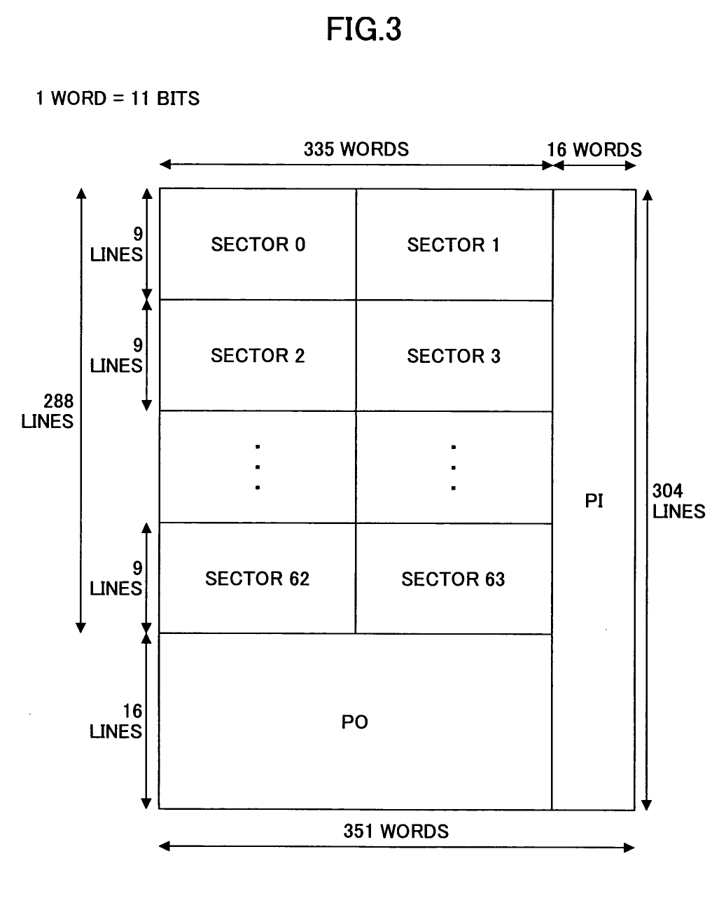

FIG. 3 is a diagram illustrating a structure of the data obtained by appending error correcting data to 64 sectors data.

First, Parity Outer data (PO) are appended in the vertical direction (column) in FIG. 3. The parity outer data are generated by using Reed Solomon Codes RS (304,288,17). After that, Parity Inner (PI) data are appended in the horizontal direction in FIG. 3. The parity inner data are generated by using Reed Solomon Codes RS (351,335,17).

In FIG. 3, the left three bits of the address information without being error-corrected are not illustrated.

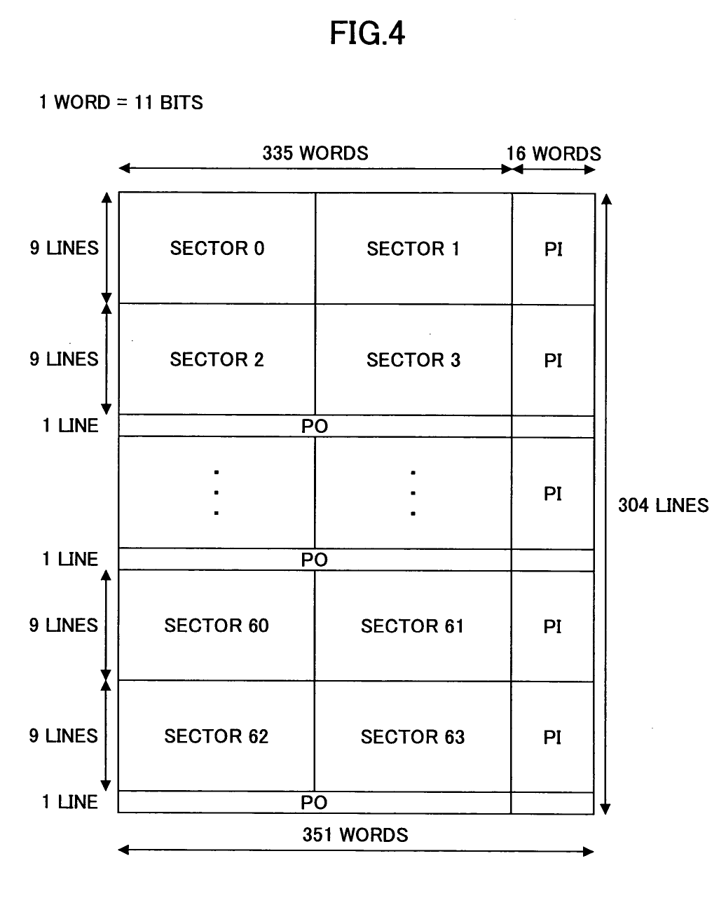

FIG. 4 is a diagram illustrating data obtained by interleaving the PO data lines.

As illustrated in FIG. 4, totally sixteen PO data lines are interleaved into sector data, for every four sectors (eighteen lines) with each PO data line (including PI data in the line) being interleaved into each four sectors (eighteen lines). Due to this processing, data lines not including address information are dispersed, thereby improving efficiency of reading addresses during data access.

Similarly, in FIG. 4, the left three data bits of the address information not being error corrected is not illustrated.

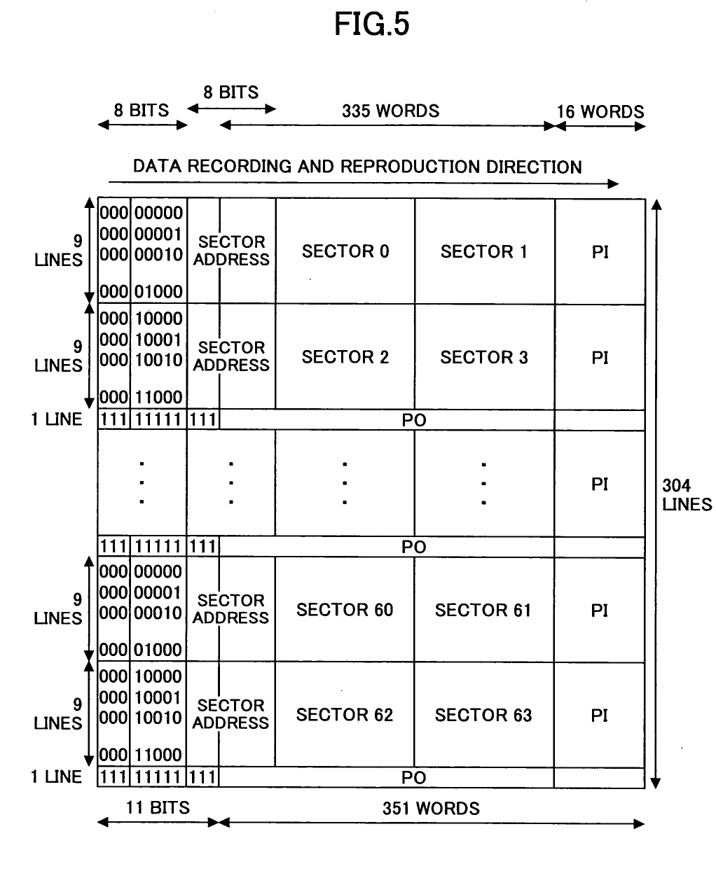

FIG. 5 is a diagram illustrating data obtained by appending address identification data (the eight bits on the left side in each line) to each data line after interleaving. In FIG. 5, the left three data bits of the address information not subject to error correction are also indicated.

As illustrated in FIG. 5, eighteen lines of data, including four sectors and one line of the PO data, are operated as a block, and data appended to this block include a five-bit line number and three-bit data for determining a delimiter of each eighteen lines.

In order to determine data in units of two sectors, the five-bit line number is defined to be 0 to 8 for the first 9 lines, and to be 16 to 24 for the last 9 lines. The PO data line is defined to have a line number of 31 (that is, 11111) so as to be clearly distinguished from other lines. In addition, invalid data [111] are assigned to the three-bit data in the PO data line, which are not error-corrected. The three-bit data for determining the delimiter of each eighteen lines is defined to be [111] for a PO data line, and to be [000] for the other lines. With the above definitions, it is easy to determine whether a line includes the address information.

The size of data contained in one line is 352 words, with one word equaling eleven bits. With eleven bits of data being units, the data contained in one line are transformed into four eight-level data items, and are recorded in the optical disk by multi-level recording. Data recording and reproduction in the optical disk are performed sequentially along the line direction indicated in FIG. 5.

When reading data from the optical disk, first, it is necessary to read the sector address. For lines whose address identification data item has the most significant three bits equaling [111], these lines are ignored because they are PO data lines. When it is detected that the most significant three bits of the address identification data item equal [000], the subsequent five-bit line number is read to obtain the address information in units of nine lines (two sectors). After error correction is executed by using ECC data of the address information, the sector address is read. Because error correction is performed, confidence in the value of the address is high.

Because from the thus obtained sector address, it is possible to identify a data line in a data block which forms a product code. The data block (one ECC block), which forms the product code, is stored in a semiconductor memory, or another storage device, by inputting data lines equaling 64 sectors (including PO data lines). Then, error correction is executed by using the PI and PO data, while taking special consideration that the PO data lines are interleaved.

According to the data recording method of the present embodiment, the user data and the sector addresses are recorded in the optical disk so that the user data and the sector addresses are separated and arranged to form data blocks. Due to this, it is easy to read the sector addresses.

In addition, because multi-level recording is performed with error correcting data associated with the product code being appended, the data recording method of the present embodiment is suitable for a situation in which errors occur randomly, and facilitates reading of the sector addresses.

Specifically, error correcting data, which are related to a product code with x bits to be defined as one word (x is an integer, and x≧3), are appended, and binary data having x bits are transformed into a number of m n-level data items (m is an integer, and m≧2, n is an integer, and n≧3), and are recorded in the recording medium. Therefore, the one-word error correcting data can be adjusted to match the bit number of the binary data in the multi-level recording and the binary data to be transformed to the multi-level data, and this is suitable for multi-level recording.

In addition, if the one-word error correcting data item is set to have eleven bits, a data structure can be constructed which is suitable for multi-level recording of the related art.

In addition, because one address data item is appended to two sector data sets, a data structure of low redundancy is obtainable.

Further, because address identification data are appended to data series units for correcting inner codes in the product codes, this facilitates reading of the sector addresses.

### Second Embodiment

The recording method of the present embodiment is related to data recording in a recording medium such as an optical disk. Below, an optical disk is taken as an example of the recording medium.

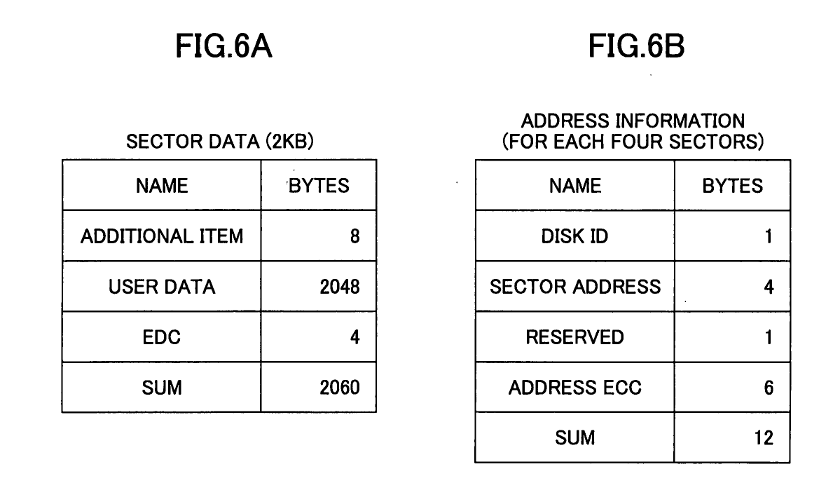

FIG. 6A is a diagram illustrating a data structure of sector data including user data in units of 2 KB (that is, 2048 bytes) to be recorded in a recording medium.

FIG. 6B is a diagram illustrating a data structure of address information indicating an address of a sector.

The sector data include user data, additional information, and EDC (Error Detection Code).

The address information includes an optical disk identification (ID), sector addresses, reserved data, and address ECC (Error correcting code). The reserved data are preliminary data indicating future expandability. Here, it is assumed that the address information is appended to each four sectors, and the address of each four sectors is defined to be the sector address equaling integral multiples of four.

The address ECC is four-byte data for error correction which is added to the address data.

In the present embodiment, the user data and the sector addresses, which correspond to the recording data sets and the address data items, respectively, are separated and arranged to form data blocks, and are recorded in the optical disk.

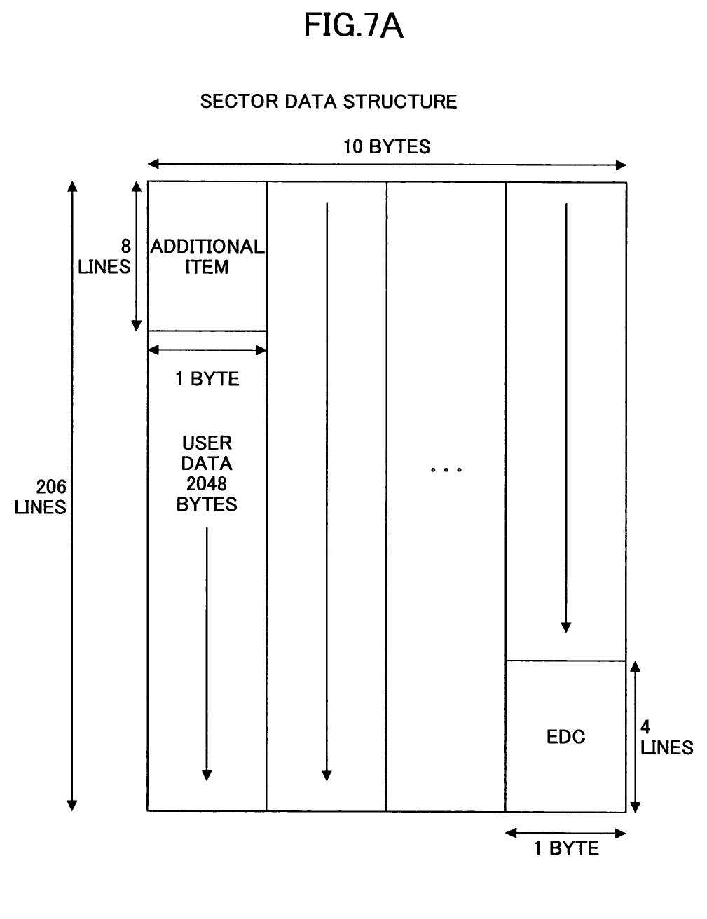

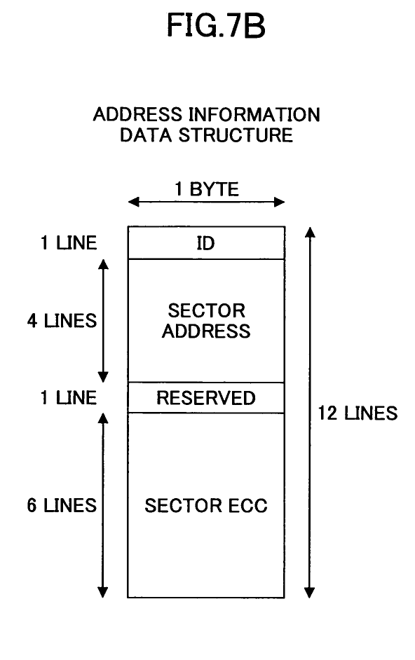

FIG. 7A is a diagram illustrating a data structure of the sector data.

FIG. 7B is a diagram illustrating a data structure of the address information.

In FIG. 7A and FIG. 7B, data contained in one sector include data equaling 10 bytes×206 lines. These data are sequentially arranged in the vertical direction in FIG. 7A.

The address information includes data equaling 1 byte×12 lines.

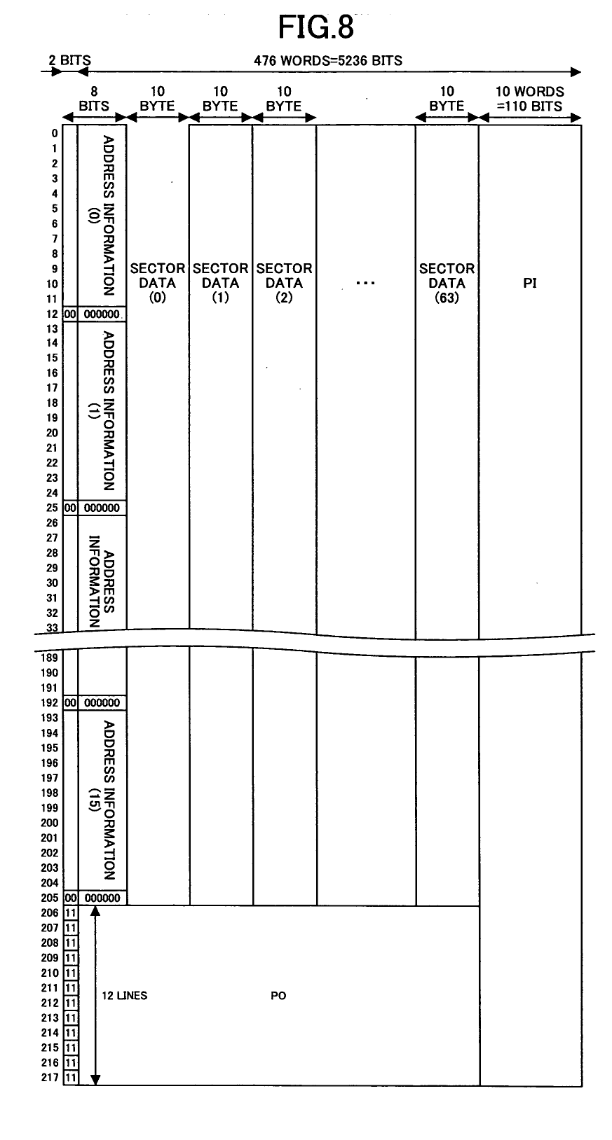

FIG. 8 is a diagram illustrating a structure (1 ECC block) of the data obtained by appending error correcting data to 64 sectors data by using a product code.

In the data structure shown in FIG. 8, the size of the data contained in one line is calculated as follows:
8 bits+10 bytes (80 bits)×64 sectors+10 words (110 bits)=5238 bits.

Here, one word is defined to be eleven bits.

Among the 5238 bits of data, data concerned with error correction are the 5236 bits (476 bytes) on the right side. Error correction is not performed on the left two bits of the address information. Because the address information includes the ECC data, and because error correction on the address information is not necessary after searching for data on the optical disk, or after reading out addresses for detecting an error correcting block, even if the address information is excluded from error correction operations on the user data, there is not any problem.

Error correcting data are appended in the following way.

First, Parity Outer data (PO) are appended in the vertical direction (column) in FIG. 8. The parity outer (PO) data are generated by using Reed Solomon Codes RS (218,206,13). After that, Parity Inner (PI) data are appended in the horizontal direction in FIG. 8. The parity inner (PI) data are generated by using Reed Solomon Codes RS (476,466,11).

The address information corresponding to 12 lines is treated as a block. Because each four sectors is assigned one piece of the address information, among 64-sector data, that is, in one ECC block, there are sixteen pieces of address information. In order to uniformly arrange these pieces of address information among 206 lines, as an irregular way, one-byte invalid data (00000000) are inserted. The number of the inserted invalid data (that is, the total byte number of the invalid data) is 206−12×16=14.

For example, among the total 206 lines (line number: 0 to 205), 14 invalid data are inserted into lines 12, 2, 115, 128, 141, 154, 179, 192, and 205.

In addition, invalid data [11] are assigned to the two bits in the PO data line, which is not error-corrected.

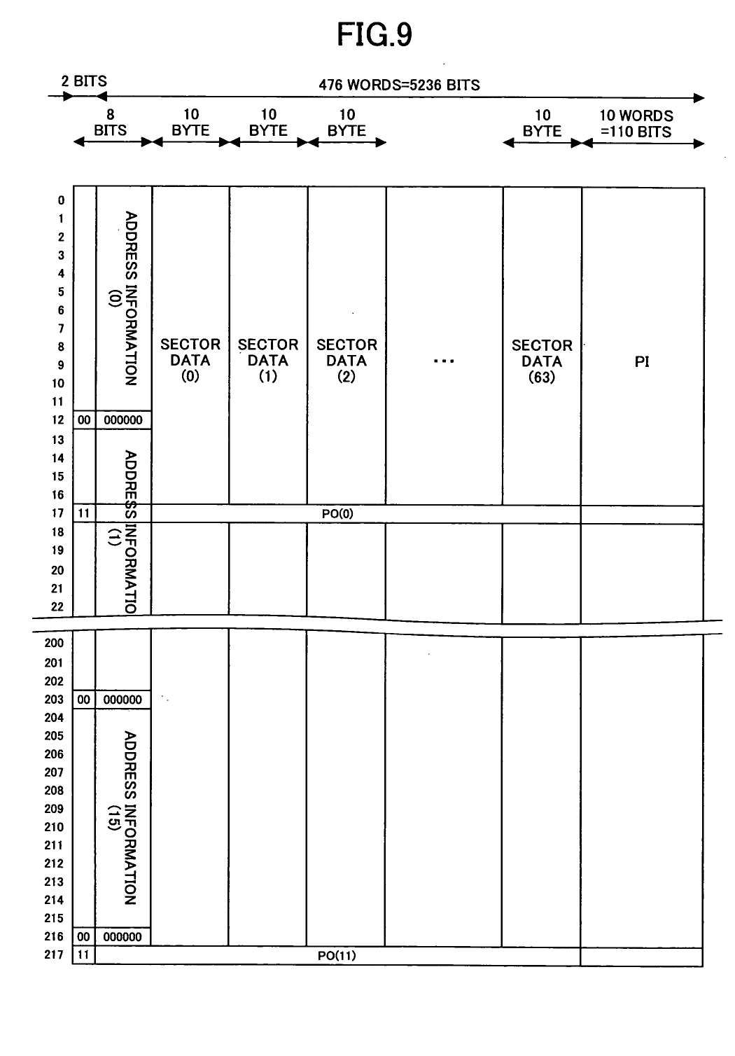

FIG. 9 is a diagram illustrating data obtained after interleaving the PO data lines.

FIG. 9 illustrates a somewhat irregular method of interleaving for nearly uniformly distributing twelve lines of PO data including PI data in each line among 218 lines. For example, the line number (from line 0 to line 217) of the line in which the PO data are arranged may be 17, 35, 54, 72, 90, 108, 126, 144, 163, 181, 199, and 217.

Due to this processing, data lines not including address information are dispersed, thereby improving efficiency of reading addresses during data access.

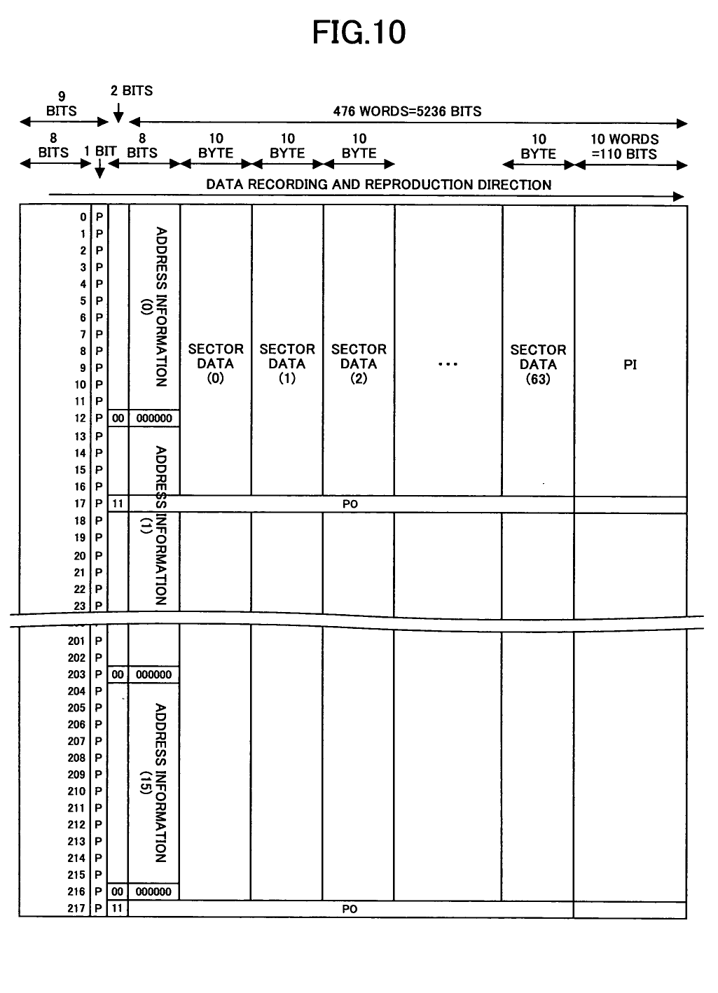

FIG. 10 is a diagram illustrating data obtained by appending address identification data (the nine bits on the left side in each line) to each data line after interleaving. In FIG. 10, the left eight bits of the nine bits indicate the line number (0 to 217) in one ECC block. The remaining one bit, which is indicated by “P” in FIG. 10, represents a one-bit result of an EXCLUSIVE-OR operation of the bits of the eight-bit line number data. With this data structure, it is possible to detect errors in the appended nine-bit data. Further, because the line numbers are consecutive figures, from plural line numbers it is possible to correctly predict other line numbers.

From the line numbers, data lines including the address information can be identified, and error correction is executed by addressing ECC data in the address information. By reading the sector address after the error correction, it is possible to search data on the optical disk or detect an ECC block. After detecting the ECC block, considering that the PO data lines have been interleaved, error correction is executed by using the PI and PO data.

The size of data contained in one line is 477 words, with one word equaling eleven bits. With eleven bits of data being units, the data contained in one line are transformed into four eight-level data items, and are recorded in the optical disk by multi-level recording. Data recording and reproduction in the optical disk are performed sequentially along the line direction indicated in FIG. 10.

According to the data recording method of the present embodiment, the user data and the sector addresses are recorded in the optical disk so that the user data and the sector addresses are separated and arranged to form data blocks. Due to this, it is easy to read the sector addresses.

In addition, because multi-level recording is performed with error correcting data associated with the product code being appended, the data recording method of the present embodiment is suitable for situations in which errors occur randomly, and facilitates reading of the sector addresses.

Specifically, error correcting data, which are related to a product code with x bits to be defined as one word (x is an integer, and x≧3), are appended, and binary data having x bits are transformed into a number of m n-level data items (m is an integer, and m≧2, n is an integer, and n≧3), and are recorded in the recording medium. Therefore, the one-word error correcting data item can be adjusted to match the bit number of the binary data in the multi-level recording and the binary data to be transformed to the multi-level data, and this is suitable to multi-level recording.

In addition, because the one-word error correcting data item is set to have eleven bits, a data structure can be constructed which is suitable for multi-level recording of the related art.

In addition, because one address data item is appended to four sector data sets, a data structure of low redundancy is obtainable.

Further, because address identification data items are appended to data series units for correcting inner codes in the product codes, this facilitates reading of the sector addresses.

### Third Embodiment

In the present embodiment, a recording device according to a third embodiment of the present invention is described.

The recording device of the present embodiment operates following the recording methods of the previous embodiments to record data in a recording medium such as an optical disk. Below, an optical disk is taken as an example of the recording medium.

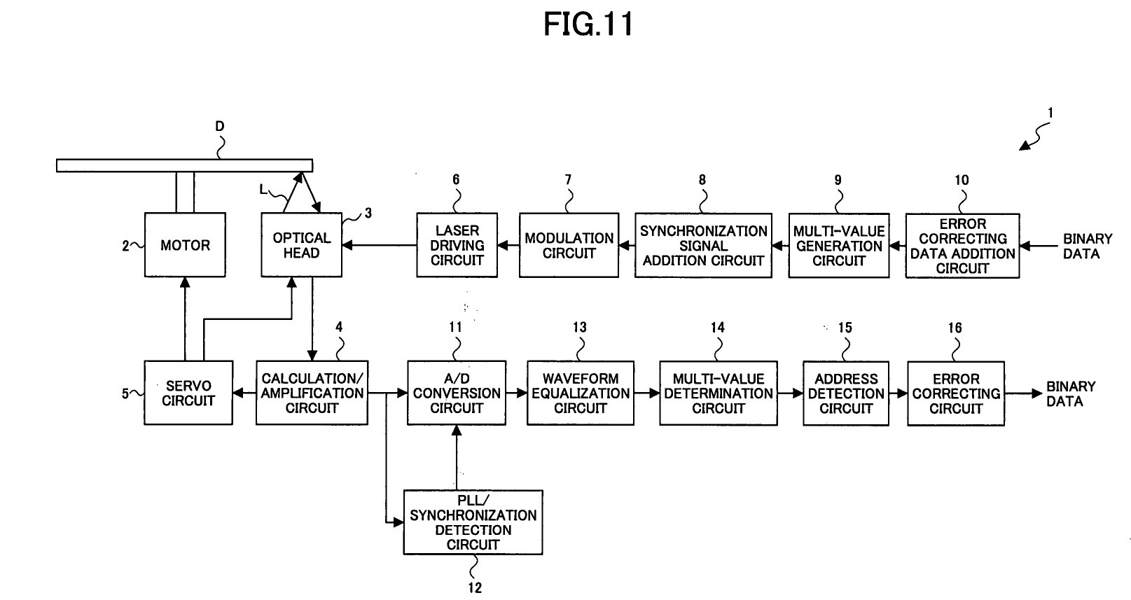

FIG. 11 is a block diagram illustrating an example of a configuration of a recording device 1 according to the present embodiment of the present invention.

As illustrated in FIG. 11, the recording device 1 records data on the surface of an optical disk D, or reproduces data recorded on the surface of the optical disk D.

The recording device 1 includes a motor 2, an optical head 3, a calculation and amplification circuit 4, a servo circuit 5, a laser driving circuit 6, a modulation circuit 7, a synchronization signal addition circuit 8, a multi-level generation circuit 9, an error correcting data addition circuit 10, an A/D conversion circuit 11, a PLL and synchronization detection circuit 12, a waveform equalization circuit 13, a multi-level determination circuit 14, an address detection circuit 15, and an error correcting circuit 16.

For example, spiral or concentric tracks are formed on the surface of the optical disk D, and marks are recorded along the tracks. The tracks meander slightly at a certain period.

The motor 2 drives the optical disk D to rotate. The optical head 3 emits a laser beam L on the optical disk D to record marks on the optical disk D. By scanning the recorded marks with the laser beam L, electrical signals are generated and output.

The calculation and amplification circuit 4 amplifies the signals output from the optical head 3, and generates and outputs reproduction signals corresponding to the marks on the optical disk D, or focus error signals indicating whether the laser beam L is focused on the recording surface of the optical disk D, or tracking error signals indicating whether the laser beam L accurately scans along the tracks on the optical disk D.

The servo circuit 5, according to the focus error signals or the tracking error signals, signals corresponding to wobbling of the tracks, controls the laser beam L to be focused on the recording surface of the optical disk D, or controls the laser beam L to accurately scan along the tracks on the optical disk D, or rotates the optical disk D with a constant linear velocity or a constant angular velocity.

The laser driving circuit 6, according to the signal output from the modulation circuit 7, outputs signals for driving the laser beam L to record marks on the optical disk D.

The modulation circuit 7 outputs signals indicating sizes of marks and spaces between marks, which are respectively specified according to the input multi-level data items. Note that no mark is recorded when the input value is zero.

The synchronization signal addition circuit 8 inserts synchronization signal data into each data line.

The multi-level generation circuit 9 transforms the input binary data having eleven bits into multi-level data items (four symbols of eight-level data items).

Error correcting data addition circuit 10 appends data to input data for error correction. That is, the error correcting data addition circuit 10 operates according to the recording methods as described in the previous embodiments.

The A/D conversion circuit 11 converts the reproduction signals from the calculation and amplification circuit 4 into digital signals.

The PLL (Phase Locked Loop) and synchronization detection circuit 12 detects the synchronization signals in the reproduction signals, and outputs clock signals in synchronization with the multi-level data.

The waveform equalization circuit 13 equalizes waveforms of input signals.

The multi-level determination circuit 14 determines multi-level data, and outputs binary data.

The address detection circuit 15 reads sector addresses from address identification data, and detects a data block (ECC block) which forms a product code.

The error correcting circuit 16 performs error correction by using the error correcting data.

Although not illustrated in FIG. 11, a mechanism is provided to move the optical head 3 along the radial direction of the optical disk D to search data on the surface of an optical disk D. In addition, components not illustrated in FIG. 11 also include interface circuits for storage devices used in computers, or microprocessors for controlling the overall operations of the optical disk drive, and so on.

For example, the optical disk D may be a DVD+RW, and the optical head 3 may be a laser diode emitting a laser beam having a wavelength of 650 nm. Alternatively, the optical head 3 may also be a blue laser having a wavelength of, for example, 405 nm, and accordingly, the optical disk D may be a phase transition type optical disk.

Next, operations of the recording device 1 is described.

First, a description is made of the operations of transforming binary data into multi-level data and recording the multi-level data in the optical disk D.

As described with reference to FIG. 1A, FIG. 1B, and FIG. 6A, FIG. 6B, binary data are input, and additional information and EDC (Error Detection Code) are appended to each user data set having size of 2 KB. Further, optical disk identification data, sector address data, and address ECC data are generated. Then, as described with reference to FIG. 3 and FIG. 8, data contained in 64 sectors are input in a memory (a not-illustrated memory in the error correcting data addition circuit 10) in which one word is defined to include 11 bits.

Afterward, by operations of Reed Solomon codes, PO data and PI data are generated, and are input to the memory. In the interleaving operations as illustrated in FIG. 4, when outputting lines of data from the memory, one PO data line, which includes the PO data, may be output for every eighteen data lines. Alternatively, in the interleaving operations as illustrated in FIG. 9, when outputting lines of data from the memory, one PO data line, which includes the PO data, may be output each time specified line numbers are output. In this way, the address identification data items, as illustrated in FIG. 5 or FIG. 10, are appended to the header of each line of output interleaved data, After the above operations, the error correcting data addition circuit 10 outputs the data as illustrated in FIG. 5 or FIG. 10.

Then, in the multi-level generation circuit 9, the binary data items having eleven bits are transformed into multi-level data, for example, four symbols of eight-level data items.

Next, the synchronization signal addition circuit 8 inserts synchronization signal data into each data line.

After that, the modulation circuit 7 generates signals to drive the laser to record marks corresponding to the values of the input multi-level data.

Then, the optical head 3 records marks on the optical disk D.

Below, a description is made of the operations of reading multi-level signals from the optical disk D, executing multi-level determination, and outputting binary data.

The optical head 3 emits a laser beam of preset intensity onto the optical disk D, and converts the reflected light to electrical signals by optoelectronic conversion. The obtained electrical signals are input to the calculation and amplification circuit 4, and the servo circuit 5 controls the optical disk D to rotate stably, performs tracking or focusing control of the optical head 3, and reproduces multi-level signals.

From the reproduced multi-level signals, the PLL (Phase Locked Loop) and synchronization detection circuit 12 detects the synchronization signals, and generates clock signals in synchronization with the multi-level data by the PLL circuit.

In synchronization with the clock signals, the A/D conversion circuit 11 converts the reproduction signals into digital signals, obtaining digitized multi-level data.

Then, the waveform equalization circuit 13 equalizes waveforms of the input signals, and the multi-level determination circuit 14 determines multi-level data, and outputs binary data in which one word includes eleven bits.

In synchronization with the synchronization signals detected by the PLL (Phase Locked Loop) and synchronization detection circuit 12, each line of data is input to the address detection circuit 15.

The address detection circuit 15 reads the address identification data at the header of each data line. And then, according to the sector addresses, The address detection circuit 15 detects data of a data block (ECC block) which forms a product code and outputs the data.

In the error correcting circuit 16, data of a data block forming the product code are input in a memory (a not-illustrated memory in the error correcting data addition circuit 10) in which one word is defined to include 11 bits. Here, the address identification data at the header of each data line are not input to the memory, but only data subsequent to the header are input.

Further, because the PO data line is interleaved, in order to de-interleave the PO data line, the addresses are changed so as to obtain the data structure as illustrated in FIG. 3 or FIG. 8, and then the data are input to the memory. Then, error detection and error correction are executed by using the PI and PO data, and the binary data after correction are output.

According to the data recording device of the present embodiment, the user data and the sector addresses are separated and arranged to form data blocks, and it is easy to read the sector addresses. In addition, the product code is used, the data recording device of the present embodiment is suitable for situations in which errors occur randomly, and facilitates reading of the sector addresses. Further, because one-word error correcting data can be adjusted to match the bit number of the binary data in the multi-level recording and the binary data are to be transformed to the multi-level data, this makes the data recording device of the present embodiment suitable for multi-level recording.

In addition, because the one-word error correcting data item is set to have eleven bits, a data structure can be constructed which is suitable for multi-level recording of the related art.

In addition, because one address data item is appended to two or four sector data sets, a data structure of low redundancy is obtainable.

Further, because address identification data are appended to data series units for correcting inner codes in the product codes, this facilitates reading of the sector addresses.

The optical disk D in the present embodiment corresponds to the data recording medium of the present invention. According to the data recording medium as described in the present embodiment, because the user data and the sector addresses are separated and arranged to form data blocks, it is easy to read the sector addresses. In addition, because the product code is used, the data recording medium of the present invention is suitable for situations in which errors occur randomly, and facilitates reading of the sector addresses. Further, because one-word error correcting data can be adjusted to match the bit number of the binary data in the multi-level recording and the binary data to be transformed to the multi-level data, this makes the data recording medium of the present invention suitable for multi-level recording.

In addition, because the one-word error correcting data item is set to have eleven bits, a data structure can be constructed which is suitable for multi-level recording of the related art.

In addition, because one address data item is appended to two or four sector data, a data structure of low redundancy is obtainable.

Further, address identification data are appended to data series units for correcting inner codes in the product codes, which facilitates reading of the sector addresses.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2004-072670 filed on Mar. 15, 2004, the entire contents of which are hereby incorporated by reference.

1. A data recording method for recording a data set in a data recording medium, said method comprising the steps of:
appending an address data item to the recording data set;
separating and arranging a plurality of the recording data sets and the address data item to form a data block; and
recording the recording data sets so that error correcting data associated with a product code are appended to data including said recording data sets in the data block.

2. The data recording method as claimed in claim 1, wherein
x bits are defined to be one word in the product code (x is an integer, and x≧3), and said method further includes a step of
transforming a number of x binary data items into a number of m n-level data items (m is an integer, and m≧2, n is an integer, and n≧3) to record the recording data set.

3. The data recording method as claimed in claim 2, wherein x equals 11.

4. The data recording method as claimed in claim 2, wherein one address data item is appended to a plurality of the recording data sets.

5. A data recording device for recording a data set in a data recording medium, said data recording device comprising:
an appending unit configured to append an address data item to the recording data set;
a block formation unit configured to separate and arrange a plurality of the recording data sets and the address data item to form a data block; and
a recording unit configured to record the recording data set so that error correcting data associated with a product code are appended to data including the recording data sets in the data block.

6. The data recording device as claimed in claim 5, wherein
x bits are defined to be one word in the product code (x is an integer, and x≧3), and
the recording unit transforms a number of x binary data items into a number of m n-level data items (m is an integer, and m≧2, n is an integer, and n≧3) to record the recording data set.

7. The data recording device as claimed in claim 6, wherein x equals 11.

8. The data recording device as claimed in claim 6, wherein one address data item is appended to a plurality of the recording data sets.

9. A data recording medium in which a data set is recorded, wherein
an address data item is appended to the recorded data set;
a plurality of the recorded data sets and the address data item are separated and arranged to form a data block; and
the recorded data set is recorded so that error correcting data associated with a product code are appended to data including the recorded data sets in the data block.

10. The data recording medium as claimed in claim 9, wherein
x bits are defined to be one word in the product code (x is an integer, and x≧3); and
a number of x binary data items are transformed into a number of m n-level data items (m is an integer, and m≧2, n is an integer, and n≧3) and are recorded.

11. The data recording medium as claimed in claim 10, wherein x equals 11.

12. The data recording medium as claimed in claim 10, wherein one address data item is appended to a plurality of the recorded data sets.
